(19) United States
(12) Patent Application Publication
(10) Pub. No.: US 2006/0156555 A1
(43) Pub. Date: Jul. 20, 2006

(54) Cutter unit for a shaver and shaver with a cutter

(76) Inventors: Michael Janny, Klagenfurt (AT); Wolfgang Johannes Obermann, St. Jakob (AT)

Correspondence Address: PHILIPS INTELLECTUAL PROPERTY & STANDARDS, P.O. BOX 3001, BRIARCLIFF MANOR, NY, 10510, US

(21) Appl. No.: 10/543,392

(22) PCT Filed: Jan. 21, 2004
(86) PCT No.: PCT/IB04/50044

§ 371 Date: Jul. 26, 2005

(51) Int. Cl. B26B 21/58

(52) U.S. Cl. 30/346.54; 30/346.51

(57) ABSTRACT

A cutter unit (16) for a shaver (1) comprises a base part (19) and cutting-edge carriers (21, 22, 23, 24, 25), the base part (19) and the cutting-edge carriers (21 to 25) being formed by means of a single plastics part (36) that is all in one piece and the plastics part (36) being coated with a metal coating (37) in that region of the cutting-edge carriers (21 to 25) that is intended to form the cutting edges (31, 32).

The invention relates to a cutter unit for a shaver, which shaver comprises the cutter unit and a companion cutter, which companion cutter cooperates with the cutter unit to give a cutting action and can be applied to a person's skin, the cutter unit having a base part and cutting-edge carriers that are connected to the base part and extend away from the base part, on which cutting-edge carriers cutting edges are provided.

The invention also relates to a shaver, which shaver has the cutter unit and a companion cutter, which companion cutter cooperates with the cutter unit to give a cutting action and can be applied to a person's skin, the cutter unit being produced in accordance with the design specified in the opening paragraph.

A cutter unit of the kind specified in the opening paragraph and a shaver of the kind specified in the opening paragraph are known, for example, from U.S. Pat. No. 5,207,731 A. In such known solutions, the cutter unit essentially comprises a frame-shaped cutter-lamella holder, which carries a plurality of cutter lamellae. The cutter lamellae are held at a distance from one another by means of the cutter-lamella holder in this case and, as well as by the cutter-lamella holder, the cutter lamellae are also connected together by two connecting tubes which traverse the cutter lamellae, which connecting tubes are provided to increase the resistance to bending of the cutter lamellae. In the region of their cutting edges, the cutter lamellae are of an arcuate shape in this case, as a result of which a perforated shear foil that is provided as a companion cutter likewise assumes an arcuate shape of this kind. In such known solutions, it is a fact that the manufacture of the cutter unit requires a relatively large number of individual components to be processed, which leads to relatively high costs because of the amount of work called for by assembly and the expensive automation that the assembly operations require. It is also necessary when manufacturing the known cutter unit for checks to be made, particularly to determine whether all the cutter lamellae are present in a completed cutter unit. If a completed cutter unit is found to have a cutter lamella missing, this cutter unit has to be rejected, which is equally disadvantageous as far as the lowest possible manufacturing costs are concerned.

It is an object of the invention to avoid the circumstances described above and to realize an improved cutter unit and an improved shaver.

To achieve the object stated above, features according to the invention are provided in a cutter unit according to the invention, thus enabling a cutter unit according to the invention to be characterized in the manner stated below, namely:

A cutter unit for a shaver, which shaver comprises the cutter unit and a companion cutter, which companion cutter cooperates with the cutter unit to give a cutting action and can be applied to a person's skin, wherein the cutter unit has a base part and cutting-edge carriers that are connected to the base part and extend away from the base part, on which cutting-edge carriers cutting edges are provided, and wherein the base part and the cutting-edge carriers are formed by a plastics part that is all in one piece, and wherein the plastics part is coated with a metal coating at least in that region of the cutting-edge carriers that is intended to form the cutting edges.

To achieve the object stated above, features according to the invention are provided in a shaver according to the invention, thus enabling a shaver according to the invention to be characterized in the manner specified below, namely:

A shaver, which shaver has the cutter unit and a companion cutter, which companion cutter cooperates with the cutter unit to give a cutting action and can be applied to a person's skin, the cutter unit being realized in accordance with the invention and being able to be characterized in the manner specified above.

What is achieved by the provision of the features according to the invention is that, advantageously and in a structurally simple manner, the cutter unit can be produced with only low manufacturing costs—in particular in comparison with the known solutions described above. A further advantage is that a cutter unit of this kind according to the invention is very low in weight, which leads to reduced inertia when the cutter unit is being driven, which in turn leads to a reduction in noise and to less vibration.

In a cutter unit according to the invention, the application of the metal coating can be carried out for example by a vapor deposition process or by a sputtering process, or by means of some other coating technique. However, what has proved to be particularly advantageous with a cutter unit according to the invention is for the metal coating to be applied by an electroplating process. Where this is advantageous is in respect of simultaneous coating of a large number of one-piece plastics parts in a single electroplating process and in respect of manufacturing costs that are as low as possible.

With a cutter unit having a metal coating applied by an electroplating process, it has proved to be particularly advantageous if the metal coating comprises a plurality of layers of metal. A wide variety of combinations of layers of metal can be used in this case. It has proved to be particularly advantageous if a metal coating comprising the materials specified below, of the layer thicknesses that are also specified below, is applied to the plastics part that comprises only one piece, namely: electroless nickel (not more than 3 μm), strengthened nickel layer (approximately 3 μm), copper (at least 15 μm), nickel (at least 10 μm), chromium (approximately 3 to 5 μm). Other combinations of these materials are also possible.

Thus, the uppermost layer of the metal coating comprises chromium with a layer thickness of approximately 3 to 5 μm. This has proved to be particularly advantageous with regard to a long life and good cooperation with a companion cutter. It should, however, be mentioned that a metal coating may also comprise just a single layer of metal.

In addition, it should be mentioned that the following materials can be used for coating by means of an electroplating process, namely: chromium, copper, nickel, velours nickel, gold, ruthenium, silver, tin.

It should further be mentioned that it is not absolutely essential for the whole of the one-piece plastics part to be coated with a metal coating. However, the plastics part must be coated with a metal coating at least in that region of cutting-edge carriers that is intended to form the cutting edges.

It only remains to be mentioned that there are a range of plastics that are very well suited to the manufacture of the plastics part that is all in one piece and that has been or will be at least partly coated with metal by means of an electroplating process, namely: ABS=acrylonitrile butadiene styrene, ABS/PC=acrylonitrile butadiene styrene/polycarbonate, PC/PBT=polycarbonate/polybutylene terephthalate, PEI=polyetherimide, LCP=liquid crystal polymers, PE=polyethylene, PPO=polyphenylene oxide, PBT=polybutylene terephthalate.

In a cutter unit according to the invention, the solution may be such that the cutting-edge carriers are entirely covered with the metal coating, in which case the metal coating is ground away for only part of its thickness to form the cutting edges. It has, however, proved to be very advantageous if, to form the cutting edges, the metal coating is partly removed from the cutting-edge carriers. This gives the advantage that a cutter unit of this kind according to the invention causes less wear on the companion cutter with which the cutter unit cooperates, because the plastics material that is exposed due to the removal of the metal coating has a beneficial effect on the sliding movement of the cutter unit against the companion cutter in the region of the cutting edges of the cutter unit. In addition, a cutter unit according to the invention has what are termed good emergency running characteristics, which are important if the cutter unit, and possibly the companion cutter too, are degreased by a cleaning process and by cleaning agents that may possibly be used in this process.

In a cutter unit according to the invention, the metal coating may have been partly removed from the cutting-edge carriers by means of an electrochemical or even a laser cutting process to form the cutting edges. However, it has proved to be particularly advantageous in a cutter unit according to the invention if the metal coating is partly removed from the cutting-edge carriers by grinding to form the cutting edges. This is particularly advantageous with regard to enabling a cutter unit of this kind to be produced as inexpensively as possible.

In a cutter unit according to the invention, the one-piece plastics part may be of a tunnel-like configuration and consequently may comprise an approximately cuboid bottom section and an approximately semi-cylindrical top section resting on top of the cuboid bottom section. Depressions of a dished shape may be provided in the curved defining surface of the top section in this case, in which case the defining contours of the dished depressions, which defining contours are situated in the curved defining surface, may be formed to extend in an oval or almost circular shape. It has however proved to be particularly advantageous if, in a cutter unit according to the invention, the one-piece plastics part is so arranged that the cutting-edge carriers are formed by lamellae. In this case, slot-like depressions extending parallel to one another are provided in the plastics part that is all in one piece. A design in lamellar form of this kind is known per se but has proved also to be particularly advantageous in a cutter unit according to the invention with regard to achieving the best possible shaving results.

These and other aspects of the invention are apparent from and will be elucidated with reference to the embodiment described hereinafter, although the invention is not limited to this embodiment.

In the drawings:

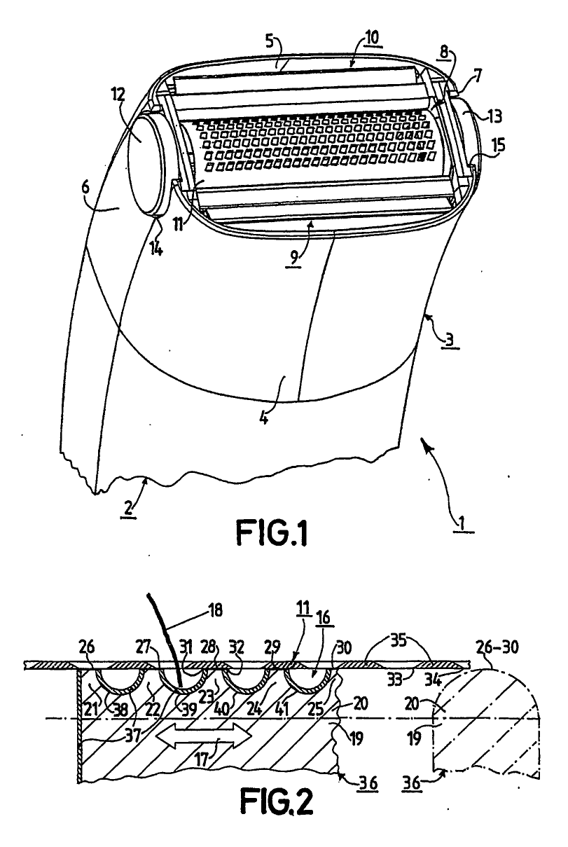

FIG. 1 is an oblique view showing part of the shaver according to the invention, which shaver includes a system for cutting short hairs having a cutter unit according to the invention.

FIG. 2 is a longitudinal section through part of the cutter unit and through part of a perforated shear foil of the shaver of FIG. 1 that cooperates with the cutter unit.

FIG. 1 shows a shaver 1, which is a so-called foil shaver and is hereinafter referred to as the device 1. The device 1 has a housing 2 to which a removable frame 3 is connected. The frame 3 has two longitudinal walls 4 and 5, and two transverse walls 6 and 7 of which only the transverse wall 6 is clearly visible in FIG. 1.

The device 1 is equipped with a system 8 for cutting short hair and with two systems 9 and 10 for cutting long hair. FIG. 1 shows the two long hair cutting systems 9 and 10 in schematic form only. The two long-hair cutting systems 9 and 10 are so-called toothed cutting mechanisms which each have a stationary toothed blade and a toothed blade that is guided, and can be driven, back and forth across the stationary toothed blade. The two long-hair cutting systems 9 and 10 and the short-hair cutting system 8 are arranged inside the frame 3. The two long-hair cutting systems 9 and 10 can be displaced from the rest position that is shown in FIG. 1 to an extended position that is not shown in FIG. 1, using displacing means that are not shown. As a companion cutter, the short-hair cutting system 8 has a perforated shear foil 11 that can be seen in FIG. 1. The perforated shear foil 11 may be applied to a person's skin, in which case a shaving process may be carried out in the applied state if the perforated shear foil 11 is moved along the skin. To obtain a cutting action, a cutter unit that is not visible in FIG. 1 cooperates with the perforated shear foil 11. The cutter unit can be driven back and forth by means of a drive motor.

The device 1 has friction-reducing discs 12 and 13 that are intended to roll over the skin of a part of a person's body and that are rotatably mounted for this purpose, in a manner that is not shown here. As is clearly visible in FIG. 1, each friction reducing disc 12 or 13 is arranged in this case in the region of a transverse wall 6 or 7 and is arranged to extend substantially in parallel with the relevant transverse wall 6 or 7. Respective recesses 14 and 15 are provided in each of the transverse walls 6 and 7 in this case and the relevant friction reducing discs 12 and 13 are arranged in the recesses 14 and 15 respectively intended for them.

As has already been mentioned, the shaver 1 has a cutter unit. FIG. 2 shows a detail of this cutter unit 16. As has also already been mentioned, the cutter unit 16 can be driven back and forth, parallel to the direction indicated by the arrow 17. The perforated shear foil 11 cooperates with the cutter unit 16, a hair 18 schematically indicated in FIG. 2 being severed by cooperation of this kind.

In an imaginary section taken perpendicularly to the arrow 17, the cutter unit 16 is of a tunnel-like shape, as indicated by a dashed and dotted line in FIG. 2. The cutter unit 16 has a base part 19 that is substantially cuboid. The base part 19 may also be described as a bottom part 19. Connected in one piece to the base part 19 (bottom part 19) is a top part 20. The top part 20 is of semi-cylindrical shape in cross-section. By using the top part 20, a plurality of cutting-edge carriers 21, 22, 23, 24 and 25 are provided. The cutting-edge carriers 21 to 25 extend away from the base part 19 of the cutter unit 16 in this case and project in the direction of the perforated shear foil 11. The cutting-edge carriers 21 to 25 are formed by lamellae that extend transversely to the direction of the arrow 17. The cutting-edge carriers 21 to 25 are each bounded in this case by a defining wall 26, 27, 28, 29, 30 extending in an arcuate shape. On each of the cutting-edge carriers 21 to 25 are provided two cutting edges 31 and 32, as is indicated in FIG. 2 in the case of the third cutting-edge carrier 23. The cutting edges 31 and 32 of each cutting-edge carrier 21 to 25 cooperate with cutting edges 33 and 34 of cutting webs 35 forming part of the perforated shear foil 11, thus enabling hairs 18 to be severed in this way.

The design of the cutter unit 16 is particularly advantageous because the base part 19 and top part 20 of the cutter unit 16, and thus the cutting-edge carriers 21 to 25 as well, are formed by means of just a single plastics part 36 which is all in one piece. In the present case, the plastics part 36 is coated with a metal coating 37 not just in the region of its top part 20 but also in the region of its base part 19. To form the cutting edges 31 and 32, this metal coating 37 is partly removed from the cutting-edge carriers 21 to 25, namely in the region of the free ends of the cutting-edge carriers 21 to 25. In the present case, the metal coating 37 is entirely removed in the region of the free ends of the cutting-edge carriers 21 to 25, which means that the cutting-edge carriers 21 to 25 come directly into operative connection with the perforated shear foil 11.

It should be mentioned that the plastics part 36 that is all in one piece need not necessarily be entirely covered with a metal coating 37. A metal coating 37 of this kind may, for example, be provided solely in the region of the top part 20 of the plastics part 36.

It should also be mentioned that the metal coating 37 does not have to be entirely removed in the region of the free ends of the cutting-edge carriers 21 to 25, but may be removed for only part of the thickness of the metal coating 37, which then means that it is the free ends of the cutting-edge carriers 21 to 25 that cooperate with the perforated shear foil 11 that are covered with a residual part of the metal coating 37.

In the present case, the cutting-edge carriers 21 to 25 are produced in such a way that grooves 38, 39, 40 and 41 are provided in the plastics part 36, which grooves 38, 39, 40 and 41 extend perpendicularly to the direction of arrow 17 and parallel to the outer surface of the plastics part 36. In the present case the grooves 38, 39, 40 and 41 are of an approximately semicircular shape. Such grooves 38, 39, 40 and 41 may however also be formed to be deeper, in which case they are then somewhat more elongated in shape.

In the present case, the metal coating 37 has been applied by an electroplating process. With regard to the metal coating 37, it should further be stated in the present case that the metal coating 37 comprises only a single layer of metal, namely a layer of chromium.

It should, however, be pointed out that the metal coating 37 may also be composed of two or three or more layers of metal.

With regard to the removal of the metal coating 37 in the region of the free ends of the cutting-edge carriers 21 to 25, it should also be mentioned that in the present case the removal was carried out by means of a grinding process. It is, however, also possible for other material removal processes to be used.

1. A cutter unit (16) for a shaver (1), which shaver (1) comprises the cutter unit (16) and a companion cutter (11), which companion cutter (11) cooperates with the cutter unit (16) to give a cutting action and can be applied to a person's skin, wherein the cutter unit (16) has a base part (19) and cutting-edge carriers (21, 22, 23, 24, 25) that are connected to the base part (19) and extend away from the base part (19), on which cutting-edge carriers (21, 22, 23, 24, 25) cutting edges (31, 32) are provided, and wherein the base part (19) and the cutting-edge carriers (21, 22, 23, 24, 25) are formed by means of a plastics part (36) that is all in one piece, and wherein the plastics part (36) is coated with a metal coating (37) at least in that region of the cutting-edge carriers (21, 22, 23, 24, 25) that is intended to form the cutting edges (31, 32).

2. A cutter unit (16) as claimed in claim 1, wherein the metal coating (37) has been applied by an electroplating process.

3. A cutter unit (16) as claimed in claim 2, wherein the metal coating (37) comprises a plurality of layers of metal.

4. A cutter unit (16) as claimed in claim 3, wherein the uppermost layer of the metal coating (37) is of chromium.

5. A cutter unit (16) as claimed in claim 1, wherein the metal coating (37) is partly removed from the cutting-edge carriers (21, 22, 23, 24, 25) to form the cutting edges (31, 32).

6. A cutter unit (16) as claimed in claim 5, wherein the metal coating (37) is partly ground away from the cutting-edge carriers (21, 22, 23, 24, 25) to form the cutting edges (31, 32).

7. A cutter unit (16) as claimed in claim 1 wherein the cutting-edge carriers (21, 22, 23, 24, 25) are formed by lamellae.

8. A shaver (1), which shaver (1) comprises the cutter unit (16) and a companion cutter (11), which companion cutter (11) cooperates with the cutter unit (16) to give a cutting action and can be applied to a person's skin, wherein the cutter unit (16) is realized in accordance with claim 1.
